(19) United States
(12) Patent Application Publication
(10) Pub. No.: US 2013/0006862 A1
(43) Pub. Date: Jan. 3, 2013

(54) System and Method of Controlling Transactions

(76) Inventor: Robert William Graham, Dayton, OH (US)

(21) Appl. No.: 13/540,605

(22) Filed: Jul. 2, 2012

Related U.S. Application Data
(60) Provisional application No. 61/504,218, filed on Jul. 3, 2011.

(51) Int. Cl. G06Q 20/40

(52) U.S. Cl. 705/44

(57) ABSTRACT

A system and method of controlling financial transactions of an account of entity having two or more authorized parties includes the steps of (a) a first authorized party presenting a first instrument to perform a transaction on the account, (b) employing an electronic communication device to send a realtime electronic authorization request for approval to a second authorized party and (c) the second party electronically replying to the request.

This application claims the benefit of earlier filed provisional application 61/504218 filed Jul. 3, 2011.

### FIELD OF INVENTION

The present invention relates generally to the field of electronically controlling transactions. More particularly, the invention relates to controlling financial transactions using two or more remote electronic verification devices.

### STATE OF THE ART

Currently, there are various security measures for controlling transactions. For example, in the banking industry, one can put limits on an account or one can put security alerts on an account. However, in the case of a joint account, either party may act independently of the other party. In cases of partnerships, corporations, or married couples, this poses significant risk to the parties as one partner may go to the bank and withdraw the entire funds from the account without the other party's consent. In todays electronic world this is even more of a concern.

Accordingly, there is a need to provide a secure system for conducting transactions in these type of relationships.

### SUMMARY OF INVENTION

It is an object to improve financial transactions.

It is a further object to make financial transactions more secure.

It is another object to prevent fraudulent transactions.

It is another object to provide controlled partner authorization of transactions.

Accordingly, the present invention is directed to a system and method of controlling financial transactions of an account of entity having two or more authorized parties. The method includes the steps of (a) a first authorized party presenting a first instrument to perform a transaction on the account, (b) employing an electronic communication device to send a realtime electronic authorization request for approval to a second authorized party and (c) said second party electronically replying to said request. The method step be can include a request for approval or denial and the step c can include a reply with approval or denial. The electronic reply can include use of cellular phone, or computer via Internet for example. The request can be made via e-mail or text message. The method further includes employing the predetermined threshold limits wherein the step (b) is performed only if the transaction amount is above a predetermined amount.

A system of the invention includes a computer based system disposed at a location of a transaction having software for creating an account for an entity having two or more authorized users for said account, wherein said software is equipped to define a threshold limit which upon meeting or exceeding said limit requires authorizations from at least two authorized parties in order to complete such transaction and which sends an electronic communication request for approval to a first authorized party real-time upon a second party presenting a first instrument at such location to perform such transaction on the account and an electronic device disposed proximate said first party and equipped for receiving said realtime electronic communication request for approval and for real-time electronically replying to said request. The system software includes a request for approval or denial and the electronic device is quipped to approve or deny such request electronically. The electronic device includes a cellular phone or computer.

### BRIEF DESCRIPTION OF THE DRAWINGS

FIG. 1 is a schematic of the invention.

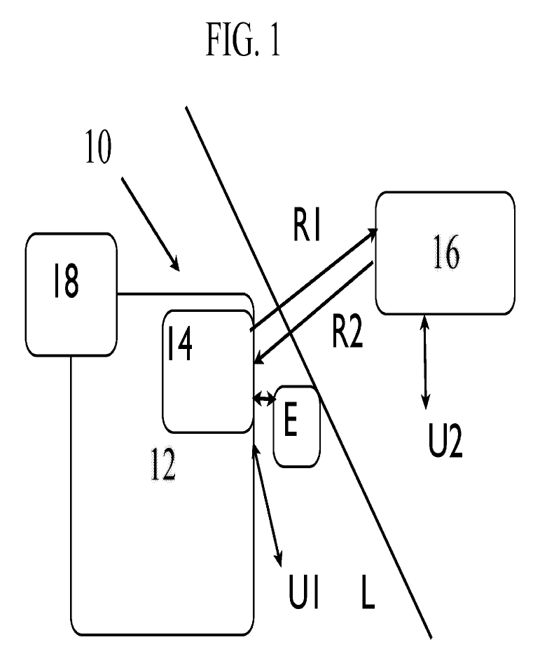

FIG. 2 is a flow chart of the invention.

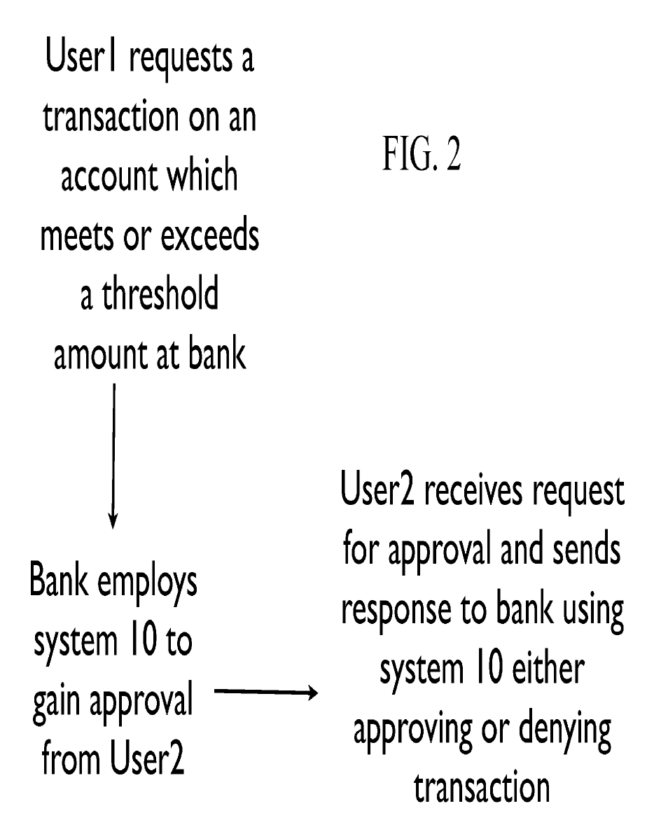

### DETAILED DESCRIPTION OF THE DRAWING

The present invention is directed to a system for performing transactions on an account which is generally designated by the numeral 10. The system 10 includes a computer based system 12 disposed at a location L of a transaction having account software 14 operably associated therewith for creating and or accessing an account for an entity E having two or more authorized users U1 and U2 for the account. The software 14 is equipped to define a threshold limit X which upon meeting or exceeding said limit requires authorizations from at least two authorized parties U1 and U2 in order to complete such transaction and which sends an electronic communication request R1 for an approval to the authorized party U2 real-time upon party U1 presenting a first instrument at location L to perform such threshold transaction on the account.

An electronic device 16 is disposed proximate party U2 and is equipped for receiving the realtime electronic communication request R1 for approval and for real-time electronically replying to said request R1 with an approval or denial response R2. The system software 14 is equipped to a request for approval or denial and the electronic device 16 is quipped to approve or deny such request electronically. Further, the software 14 is equipped to terminate the authorization request after a redetermined time if the approval response R2 is not received within a predetermined period. The electronic device 16 can be a cellular phone communicating via wireless communication or computer communicating via Internet.

The system is ideal for restricting bank or credit card transactions for authorized users on a bank or credit card account. This system can preclude a myriad of overdraft or fraudulent charges.

The system 10 is also operably connected to a database 18 which stores the authorization request data, response data in association with the account of the Users. In this way, there is a log of information which can be stored by date, time and user for each authorization request.

1. A system of the invention includes a computer based system disposed at a location of a transaction having software for creating an account for an entity having two or more authorized users for said account, wherein said software is equipped to define a threshold limit which upon meeting or exceeding said limit requires authorizations from at least two authorized parties in order to complete such transaction and which sends an electronic communication request for approval to a first authorized party real-time upon a second party presenting a first instrument at such location to perform such transaction on the account and an electronic device disposed proximate said first party and equipped for receiving said realtime electronic communication request for approval and for receiving said realtime electronic communication request for approval and real-time electronically replying to said request.

2. The system of claim 1, wherein said software includes a request for approval or denial and said electronic device is equipped to approve or deny said request electronically.

3. The system of claim 1, wherein said electronic device includes one of a computer and a cell phone.

4. A method for controlling financial transactions of an account having two or more authorized parties, which includes the steps of:
(a) a first authorized party presenting a first instrument to perform a transaction on the account,
(b) employing an electronic communication device to send a real-time electronic authorization request for approval to a second authorized party and
(c) said second party electronically replying to said request.

5. The method of claim 4, which includes a request for approval or denial .

6. The method of claim 4, which includes employing a cellular phone to perform said step (c).

7. The method of claim 4, wherein step (b) is characterized to be made by one of an e-mail and text message.

8. The method of claim 4, which further includes employing predetermined threshold limits wherein the step (b) is performed only if the transaction is above the predetermined limit.
